(19) United States
(12) Patent Application Publication
(10) Pub. No.: US 2023/0014189 A1
(43) Pub. Date: Jan. 19, 2023

(54) ACTIVE AERODYNAMIC VEHICLE SURFACE WITH FORCE SENSOR

(71) Applicant: Magna Exteriors Inc., Concord (CA)

(72) Inventors: John Robert Scott MITCHELL, Newmarket (CA); Stephen James CARON, Aurora (CA)

(73) Assignee: Magna Exteriors Inc., Concord, ON (CA)

(21) Appl. No.: 17/782,674

(22) PCT Filed: Dec. 11, 2020
(86) PCT No.: PCT/CA2020/051712

§ 371 Date: Jun. 6, 2022

Related U.S. Application Data
(60) Provisional application No. 62/950,547, filed on Dec. 19, 2019.

(51) Int. Cl. B62D 35/00; G01L 9/04; B60R 1/062

(52) U.S. Cl. CPC B62D 35/007; G01L 9/04; B60R 1/062

(57) ABSTRACT

An active aerodynamic system for a vehicle includes a movable exterior component disposed over a force sensor that is responsive to an aerodynamic force applied to the exterior surface, and a plurality of two or more linear actuators configured to move the movable exterior component responsive to the force applied to the exterior surface. A controller is configured to detect the aerodynamic force applied to the movable exterior component and to command the linear actuators to move the movable exterior component responsive to the aerodynamic force applied thereto. The controller may take into account other factors, such as vehicle speed, in determining a setting for the position of the movable exterior component and/or for determining a desired amount of aerodynamic force that the movable exterior component should have.

### FIELD

The present disclosure relates generally to an active aerodynamic surface assembly for a vehicle, and more particularly, to a movable exterior vehicle component configured to sense an aerodynamic force and to adjust position based upon the aerodynamic force.

### BACKGROUND

This section provides background information related to the present disclosure which is not necessarily prior art.

In view of increased consumer demand for motor vehicles with improved fuel efficiency as well as improved road handling, a greater emphasis is now placed on designing modern vehicles with improved aerodynamics. In an effort to reduce aerodynamic drag and lift, it is known to equip motor vehicles with a movable exterior component, such as a deployable airfoil, commonly referred to as a spoiler, that is moveable between a retracted (i.e. stowed) position and an extended (i.e. deployed) position, typically in response to a vehicular operating characteristic such as, for example, the vehicle road speed. In most systems, the deployable spoiler is driven between its stowed and deployed positions by a powered drive unit. A number of other factors besides speed can impact the aerodynamic forces on the vehicle and thus the optimal position of the active aerodynamic surface assembly.

### SUMMARY

This section provides a general summary of the disclosure, and is not a comprehensive disclosure of its full scope or all of its features.

It is an objective of the present disclosure to provide an active aerodynamic surface assembly for a vehicle that includes an exterior surface disposed over a force sensor that is responsive to an aerodynamic force applied to the exterior surface, and which also includes an actuator that is configured to move the exterior surface in response to the aerodynamic force applied to the exterior surface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view of a rear portion of a motor vehicle having a rear liftgate equipped with a powered spoiler assembly show on the deployed position.

FIG. 1B is a perspective view of a rear portion of a motor vehicle having a rear liftgate equipped with a powered spoiler assembly show on the deployed position.

FIG. 2 is a schematic cut-away side view of a powered spoiler assembly in accordance with the teachings of the present disclosure.

FIG. 3 is a schematic cut-away side view of a powered spoiler assembly with a controller in accordance with the teachings of the present disclosure.

FIG. 4 is a schematic cut-away side view of a powered spoiler assembly in accordance with the teachings of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

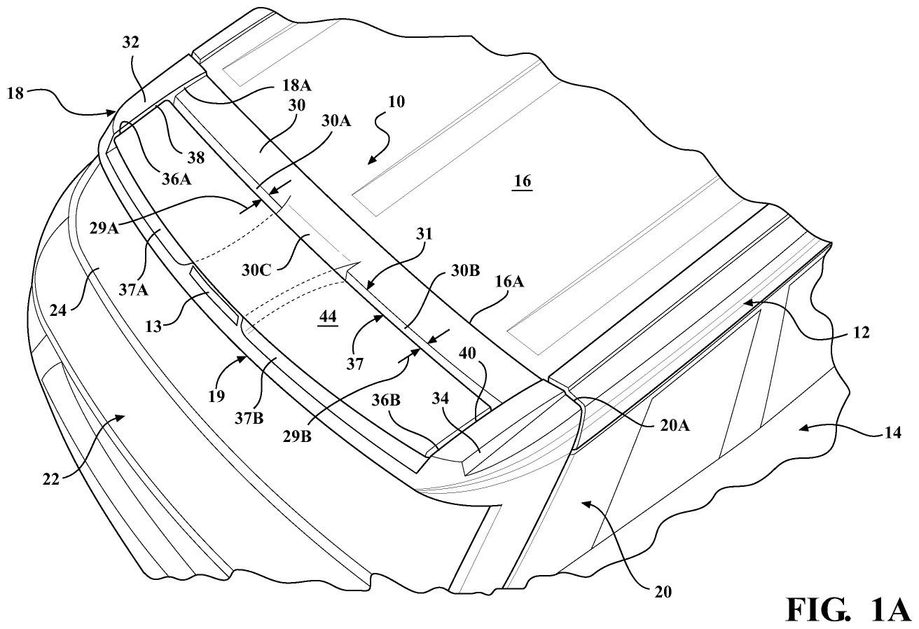

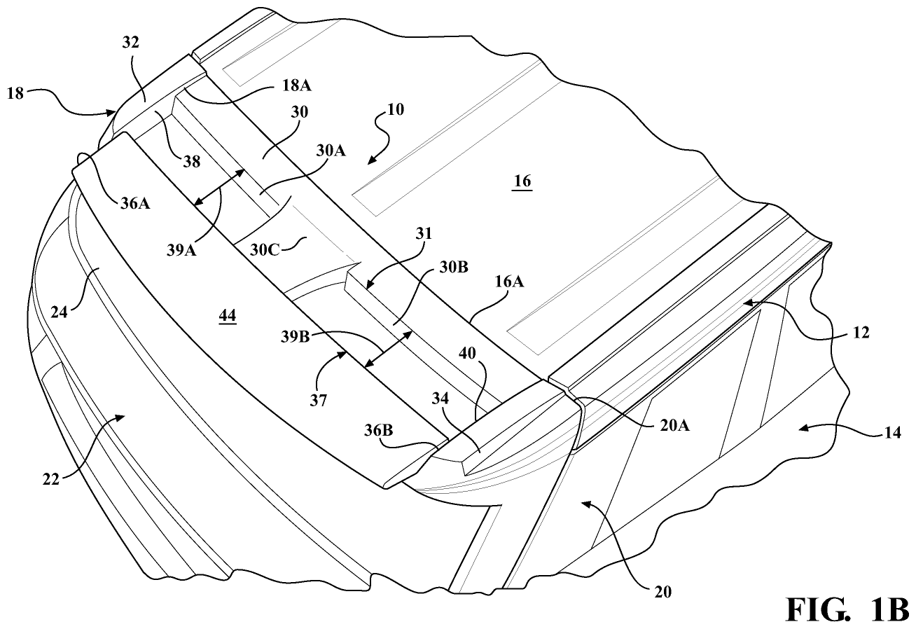

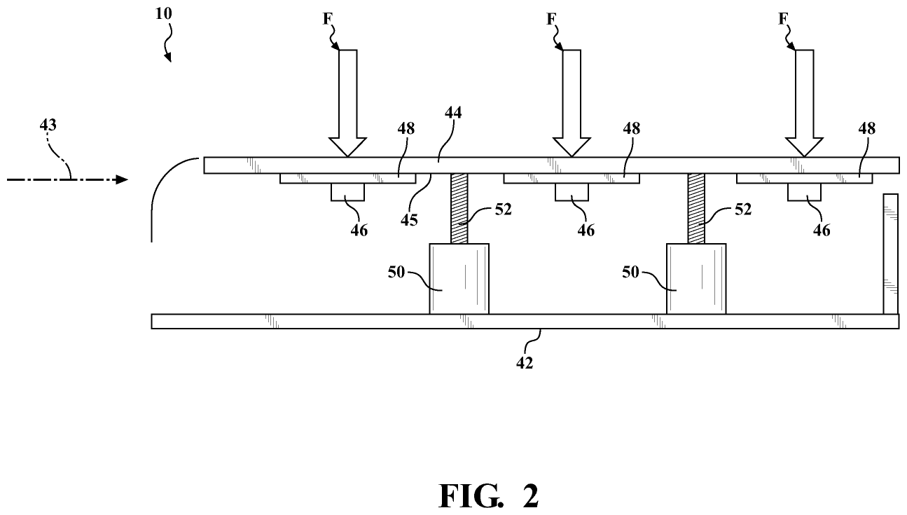

With initial reference to FIGS. 1A and 1B, a powered spoiler assembly 10 is shown in association with a motor vehicle 12 and is constructed in accordance with the teachings of the present disclosure. Motor vehicle 12 is shown, in the non-limiting example disclosed, to be a cross-over, hatchback, or SUV type vehicle having a body 14 defining a roof 16 bounded by a driver-side side panel 18 and a passenger-side side panel 20. A rear closure member, which can be a rear window or wall of the vehicle passenger compartment or a hatchback or liftgate 22 (shown in FIGS. 1A and 1B) that pivotally attached to the body 14 to move between a closed position (shown) and an open position to selectively provide access to passenger space and/or storage space within vehicle 12. Liftgate 22 is intended to illustrate a moveable rear closure member and the specific structure and function disclosed herein is not intended to limit the present disclosure. Liftgate 22 is shown to include a window 24 and, while not shown, shall include a latch device, either of the manually-operated or power-activated type, for latching liftgate 22 in its closed position and unlatching liftgate 22 for movement toward an open position. While the present disclosure is not limited to the specific arrangement shown, liftgate 22 of vehicle 12 includes a top mounting portion 16A and side panel mounting portions 18A, 20A that are configured to accept installation of powered deployable assembly 10 thereon. It is within the scope of the invention for the powered spoiler assembly 10 to be assembled as part of a liftgate module in association with liftgate 22, as part of a portion of the vehicle body 14, or as a stand-alone add-on assembly. A force sensor 46, moveable exterior component 44 and an actuator 50 are connected to the top mounting portion 16A, which is described in greater detail below with regard to FIGS. 2-4.

With continued reference to FIGS. 1A and 1B, the powered spoiler assembly 10, which is also be referred to as active aerodynamic surface assembly 10, is shown to include a contoured and aesthetically-configured outer cover unit including a top cover 30, a first or driver-side edge cover 32 and a second or passenger-side edge cover 34. While disclosed as three distinct cover elements, the covers 30, 32, 34 could alternatively be configured as a common unit. Top cover 30 extends across a portion of the width of vehicle 12 and has a trailing edge 31 that defines a first or driver-side channel opening 30A, a second or passenger-side channel opening 30B, and a raised central tunnel 30C which is configured to house vehicle accessories 13 such as, for example, a reverse light unit, a wiper motor assembly, a window washer spray unit and/or electrical connectors. The raised central tunnel 30C is positioned within the top mounting portion 16A between the drive side channel opening 30A and passenger side channel opening 30B.

The active spoiler assembly 10 includes the moveable exterior component 44 that in the present embodiment is an air deflector or spoiler panel, which has a leading edge 37 and two laterally-spaced end surfaces 36A, 36B. The leading edge 37 of the moveable exterior component 44 defines a second side of the driver side channel opening 30A and a second side of the passenger side channel opening 30B. The moveable exterior component 44 is moveable relative to the body 14 of the motor vehicle 12 and is located adjacent a trailing edge 19 of the vehicle 12. For example, the moveable exterior component 44 may move relative to the covers 30, 32, 34 between a non-deployed or “Stowed” position (shown in FIG. 1A), and one or more deployed or “Aero” positions (shown in FIG. 1B). When the moveable exterior component 44 is in the stowed position the leading edge 37 is positioned at a stowed distance 29A, 29B form the trailing edge 31, where the stowed distance 29A, 29B defines the size of the driver side channel opening 30A and the passenger side channel opening 30B when the moveable exterior component 44 is in the stowed position. When the moveable exterior component is moved to one or more aero positions (shown in FIG. 1B) the leading edge 37 of the moveable exterior component 44 is moved away from the trailing edge 31 of the top cover, thereby creating an aero distance 39A, 39B from the trailing edge 31, where the aero distance 39A, 39B defines the size of the driver side channel opening 30A and the passenger side channel opening 30B. The aero distance 39A, 39B is larger than the stowed distance 29A, 29B.

When moveable exterior component 44 is located in its stowed position, it is retracted relative to the trailing edge 31, with laterally-spaced end surfaces 36A, 36B aligned generally flush with inner edge surfaces 38, 40 of edge covers 32, 34, and the leading edge 37 is positioned closer the trailing edge 31 of the top cover 30. However, air flowing over roof 16 is permitted to flow through the driver side channel opening 30A and passenger side channel opening 30B, under moveable exterior component 44 and be discharged from a driver side channel exit 37A and passenger side channel exit 37B located at trailing edge 19. According to another embodiment, the leading edge 37 of moveable exterior component 44 can be moved in close proximity to the top cover 30, thereby closing channels 30A, 30B.

FIG. 2 shows a schematic cross-sectional side view of the powered spoiler assembly 10 in accordance with the teachings of the present disclosure. The powered spoiler assembly 10 includes a fixed structure 42 that that is rigidly fixed to the body 14 of the vehicle 12. The powered spoiler assembly 10 also includes a movable exterior component 44 that is configured to move relative to the fixed structure 42 and to interact with airflow 43, such as airflow resulting from motion of the vehicle 12. The movable exterior component 44 is a purpose-specific spoiler, such as the moveable exterior component 44 shown in FIG. 1, or a sub-part of spoiler or can take other alternate forms. Alternatively or additionally, the movable exterior component 44 is part of an external rear view mirror assembly. Alternatively or additionally, the movable exterior component 44 is part of a rear panel on or adjacent to a trailing edge of the vehicle. Alternatively or additionally, the movable exterior component 44 is adjacent to a leading edge of the vehicle 12. In another exemplary embodiment, the movable exterior component 44 is part of a grill on a front of the vehicle 12.

As also shown in FIG. 2, the movable exterior component 44 is disposed over the force sensor 46 that detects forces, such as aerodynamic force F applied to the movable exterior component 44. The force sensor 46 is attached to or integrally formed with a printed circuit board (PCB) 48 that is disposed upon or adjacent to an inner surface 45 of the movable exterior component 44. The movable exterior component 44 may be bent or deflected by the aerodynamic force F as the vehicle 12 is driven. Such deflection of the movable exterior component 44 may generate a strain force upon the PCB 48 that may be sensed by the force sensor 46. In some embodiments, the powered spoiler assembly 10 includes a plurality of force sensors 46 and PCB's 48 each configured to detect a force applied to the movable exterior component 44. For example, and as shown in FIG. 2, the movable exterior component 44 has three or more different force sensors 46 each detecting forces on a different region of the movable exterior component 44.

The actuator 50 is configured to move the movable exterior component 44 in response to the aerodynamic force F applied to the movable exterior component. In some embodiments, and as shown in FIG. 2, there are two or more actuators 50 each configured to move a corresponding part of the movable exterior component 44. In some embodiments, the movable exterior component 44 may be pivotably coupled to the fixed structure 42. Yet in other embodiments, one or more of the actuators 50 are linear actuators configured to move the movable exterior component 44 along a linear path. For example, as shown in FIG. 2, each of the actuators 50 are linear actuators, having an extensible member 52 movable in a straight line for moving the movable exterior component 44 along the linear path between a stowed first position, extended second position or any number of intermediate positions. As shown each linear actuator 50 has one extensible member 52 that may incorporate a gearmotor and a leadscrew or a rack and pinion type arrangement.

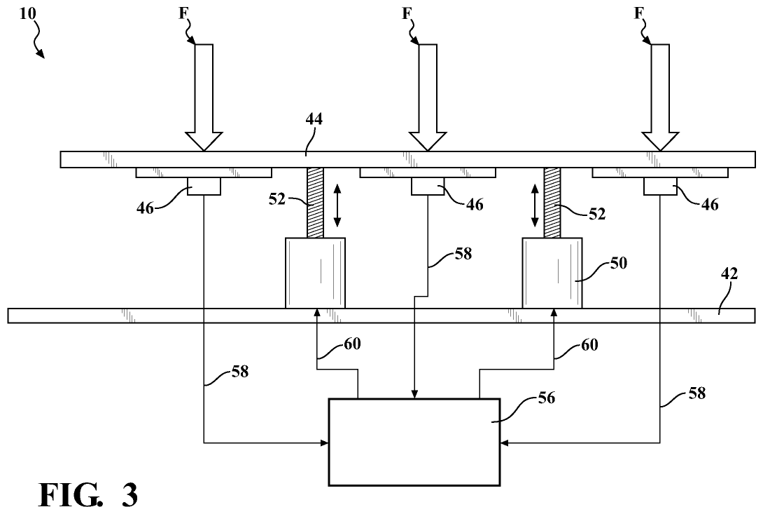

FIG. 3 shows a schematic cross-sectional side view of a powered spoiler assembly 10 with a block indicating a controller 56, such as an electronic control module (ECM) that is configured to detect the aerodynamic force F applied to the movable exterior component 44 and to command the actuator 50 or actuators 50 to move the movable exterior component 44 responsive to the aerodynamic force F applied thereto. Specifically, each of the force sensors 46 generate a force signal 58 that is sent to the controller 56. The force signal 58 can be an analog signal or a digital signal depending on the application. The controller 56 receives and monitors the force signals 58 from each of the force sensors 46 and selectively generates and transmits command signals 60 to each of the actuators 50 to cause the actuators 50 the movable exterior component 44. The controller 56 may be a stand-alone device. Alternatively, the controller 56 may be integrated within a larger device or system, such as a body control module (BCM) of the vehicle.

In some embodiments, the controller 56 may be configured to adjust a position of the movable exterior component 44 to maintain a set amount of aerodynamic force F applied thereto. The set amount of aerodynamic force F may be adjusted based on one or more factors, such as speed of the vehicle 12, steering position or cornering force, and/or an operating mode of the vehicle as well as by the aerodynamic force F detected by the force sensors 46 evaluated by the controller 56 in the form of the force signal 58 (discussed in more detail below). In some embodiments, the set amount of aerodynamic force F may be adjusted manually by a driver of the vehicle 12. In some embodiments (e.g. in some modes or in some conditions), the controller 56 may be configured to adjust a position of the movable exterior component 44 to a predetermined position. The predetermined position may be set or adjusted based on one or more factors, such as speed of the vehicle 12, steering position or cornering force, and/or an operating mode of the vehicle. In some embodiments, the predetermined position may be adjusted manually by a driver of the vehicle 12.

The controller 56 may be configured to use a control loop, such as a proportional-integral-derivative (PID) or a proportional-integral (PI) control loop, using the force signal 58 to generate the command signals 60 the actuators 50. Alternatively or additionally, the controller 56 may employ other techniques, such as a lookup table, to determine the command signals 60 to the actuators 50. The controller 56 may take into account other factors besides the aerodynamic force F, such as speed, acceleration, steering position, and/or cornering force, in determining a setting for the position of the movable exterior component 44 and/or for determining a desired amount of aerodynamic force F that the movable exterior component 44 should have at any given time.

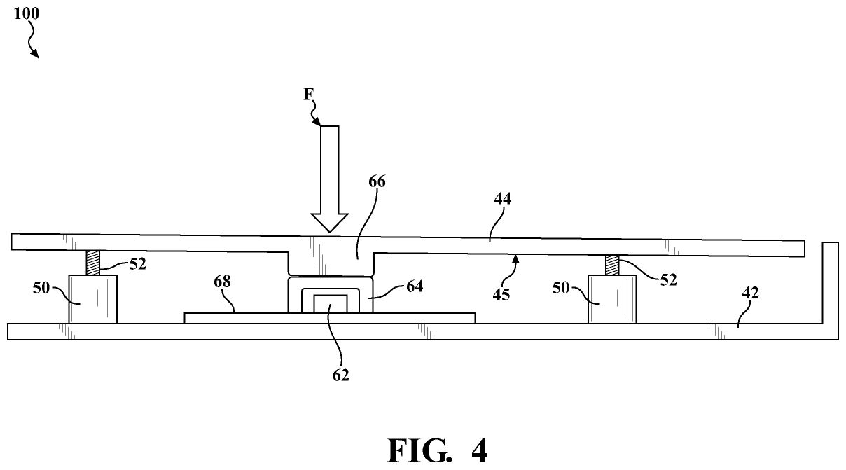

In some embodiments, and as shown in FIG. 4, a force transmitter 64 may overlie the force sensor 46 to transfer and spread the aerodynamic forces applied to the moveable exterior component applied thereto to the PCB 48 around the force sensor 46. The force transmitter 64 may be made of a resilient material, such as EPDM rubber and may have a U-Shaped cross-section as shown in FIG. 4. The force transmitter 64 may absorb excessive or abuse forces to protect the force-based sensor 128 from damage. Such a configuration is an example of an indirect coupling between the movable exterior component 44 and the force sensor 46, but other couplings may be provided, and for example a direct coupling may be provided in the case where the inner surface 45 of the movable exterior component 44 directly engages force sensor 46. As another example of a coupling, the movable exterior component 44 may be coupled directly or indirectly to a PCB 48 supporting the force sensor 46 which causes a registering of a force by the force sensor 46 when the movable exterior component 44 is acted upon by the aerodynamic force F.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An active aerodynamic surface assembly for a vehicle comprising:
a movable exterior component disposed over a force sensor that is responsive to an aerodynamic force applied to an exterior surface of the moveable exterior component; and
an actuator configured to move the moveable exterior component in response to the aerodynamic force applied to the exterior surface.

2. The active aerodynamic surface assembly of claim 1, wherein the aerodynamic force causes the exterior surface to deflect perpendicularly to the movable exterior component.

3. The active aerodynamic surface assembly of claim 1, wherein the movable exterior component is a part of an external rear view mirror assembly.

4. The active aerodynamic surface assembly of claim 1, wherein the movable exterior component is a part of a spoiler.

5. The active aerodynamic surface assembly of claim 1, wherein the movable exterior component located adjacent a trailing edge of the vehicle.

6. The active aerodynamic surface assembly of claim 1, wherein the movable exterior component is a part of a grill on or adjacent to a leading edge of the vehicle.

7. The active aerodynamic surface assembly of claim 1, wherein the actuator comprises two or more actuators each configured to move a corresponding part of the movable exterior component.

8. The active aerodynamic surface assembly of claim 1, wherein the actuator is a linear actuator configured to move the movable exterior component along a linear path.

9. The active aerodynamic surface assembly of claim 8, wherein the linear actuator comprises an extensible member movable in a straight line for moving the movable exterior component along the linear path.

10. The active aerodynamic surface assembly of claim 1 further comprising:
a vehicle having a roof bounded by a drive side panel, a passenger side panel and a rear closure member;
a top mounting portion of the rear closure member, wherein the force sensor, the moveable exterior component and the actuator are connected to the top mounting portion of the rear closure member and the moveable exterior component is moveable between a stowed position and one or more aero positions.

11. The active aerodynamic surface assembly of claim 10 further comprising:
a top cover that extends across a portion of the width of the vehicle, wherein the top cover at a trailing edge defines a first side of a driver side channel opening leading to a driver side channel and a first side of a passenger side channel opening leading to a passenger side channel;
a raised central tunnel positioned within the top mounting portion between the driver side channel and the passenger side channel, wherein the raised central tunnel is configured to house one or more vehicle accessories;
a leading edge of the moveable exterior component that defines a second side of the driver side channel opening and a second side of the passenger side channel opening, wherein when the moveable exterior component is in the stowed position, the leading edge is positioned at a stowed distance from the trailing edge.

12. The active aerodynamic surface assembly of claim 11 wherein when the moveable exterior component is moved to the one or more aero positions, the leading edge of the moveable exterior component is moved away from the trailing edge of the top cover, thereby creating an aero distance from the trailing edge where the aero distance is larger than the stowed distance.

13. The active aerodynamic surface assembly of claim 1 further comprising a printed circuit board that is disposed on an inner surface of the moveable exterior component, wherein the force sensor is connected to the printed circuit board and the force sensor senses a strain force applied to the printed circuit board, wherein the strain force is proportional to the aerodynamic force applied to the exterior surface of the moveable exterior component.

14. The active aerodynamic surface assembly of claim 13 further comprising a plurality of printed circuit boards each having a force sensor connected to one of the plurality of printed circuit boards, where the plurality of printed circuit boards are spaced apart on the inner surface of the moveable exterior component to additional strain force sensing at different locations on the inner surface of the moveable exterior component.

15. The active aerodynamic surface assembly of claim 13 further comprising a force transmitter that overlies the force sensor and the printed circuit board, wherein the force transmitter transfers and spreads the aerodynamic force from the moveable exterior component to the printed circuit board, which becomes the strain force measured by the force sensor.

16. An active aerodynamic system for a vehicle comprising:
a movable exterior component disposed over a force sensor that is responsive to an aerodynamic force applied to an exterior surface of the moveable exterior component; and
an actuator configured to move the moveable exterior component in response to the aerodynamic force applied to the exterior surface; and
a controller configured to detect the aerodynamic force applied to the movable exterior component and to command the actuator to move the movable exterior component responsive to the aerodynamic force applied thereto.

17. The active aerodynamic surface assembly of claim 16, wherein the aerodynamic force causes the exterior surface to deflect perpendicularly to the movable exterior component.

18. The active aerodynamic surface assembly of claim 16, wherein the movable exterior component is a part of an external rear view mirror assembly.

19. The active aerodynamic surface assembly of claim 16, wherein the movable exterior component is a part of a spoiler.

20. The active aerodynamic surface assembly of claim 16, wherein the movable exterior component located adjacent a trailing edge of the vehicle.

21. The active aerodynamic surface assembly of claim 16, wherein the movable exterior component is a part of a grill on or adjacent to a leading edge of the vehicle.

22. The active aerodynamic surface assembly of claim 16, wherein the actuator comprises two or more actuators each configured to move a corresponding part of the movable exterior component.

23. The active aerodynamic surface assembly of claim 16, wherein the actuator is a linear actuator configured to move the movable exterior component along a linear path.

24. The active aerodynamic surface assembly of claim 23, wherein the linear actuator comprises an extensible member movable in a straight line for moving the movable exterior component along the linear path.

25. The active aerodynamic surface assembly of claim 16 further comprising:
a vehicle having a roof bounded by a drive side panel, a passenger side panel and a rear closure member;
a top mounting portion of the rear closure member, wherein the force sensor, the moveable exterior component and the actuator are connected to the top mounting portion of the rear closure member and the moveable exterior component is moveable between a stowed position and one or more aero positions.

26. The active aerodynamic surface assembly of claim 25 further comprising:
a top cover that extends across a portion of the width of the vehicle, wherein the top cover at a trailing edge defines a first side of a driver side channel opening leading to a driver side channel and a first side of a passenger side channel opening leading to a passenger side channel;
a raised central tunnel positioned within the top mounting portion between the driver side channel and the passenger side channel, wherein the raised central tunnel is configured to house one or more vehicle accessories;
a leading edge of the moveable exterior component that defines a second side of the driver side channel opening and a second side of the passenger side channel opening, wherein when the moveable exterior component is in the stowed position, the leading edge is positioned at a stowed distance from the trailing edge.

27. The active aerodynamic surface assembly of claim 26 wherein when the moveable exterior component is moved to the one or more aero positions, the leading edge of the moveable exterior component is moved away from the trailing edge of the top cover, thereby creating an aero distance from the trailing edge where the aero distance is larger than the stowed distance.

28. The active aerodynamic surface assembly of claim 16 further comprising a printed circuit board that is disposed on an inner surface of the moveable exterior component, wherein the force sensor is connected to the printed circuit board and the force sensor senses a strain force applied to the printed circuit board, wherein the strain force is proportional to the aerodynamic force applied to the exterior surface of the moveable exterior component.

29. The active aerodynamic surface assembly of claim 28 further comprising a plurality of printed circuit boards each having a force sensor connected to one of the plurality of printed circuit boards, where the plurality of printed circuit boards are spaced apart on the inner surface of the moveable exterior component to additional strain force sensing at different locations on the inner surface of the moveable exterior component.

30. The active aerodynamic surface assembly of claim 28 further comprising a force transmitter that overlies the force sensor and the printed circuit board, wherein the force transmitter transfers and spreads the aerodynamic force from the moveable exterior component to the printed circuit board, which becomes the strain force measured by the force sensor.

31. The active aerodynamic surface assembly of claim 16 wherein the controller is configured to use a control loop such as a proportional-integral-derivative (PID) or proportional-integral (PI) control loop using the a force signal generated by the force sensor to generate a command signal from the controller to the actuator.

32. The active aerodynamic surface assembly of claim 16 wherein the controller has a lookup table that determines if a command signal is generated from the controller to the actuator.

33. An active aerodynamic system for a vehicle comprising:
a movable exterior component disposed over a force sensor that is responsive to an aerodynamic force applied to an exterior surface of the moveable exterior component; and
an actuator configured to move the moveable exterior component in response to the aerodynamic force applied to the exterior surface; and
a controller configured to detect the aerodynamic force applied to the movable exterior component and to command the actuator to move the movable exterior component responsive to the aerodynamic force applied thereto;
wherein the controller adjusts the position of the moveable exterior component to maintain a set amount of aerodynamic force on the exterior surface of the moveable exterior component based on at least one of the following factors including speed of the vehicle, steering position, cornering force and driving mode selection.

34. The active aerodynamic surface assembly of claim 33 wherein the controller is configured to use a control loop such as a proportional-integral-derivative (PID) or proportional-integral (PI) control loop using a force signal generated by the force sensor to generate a command signal from the controller to the actuator.

35. The active aerodynamic surface assembly of claim 33 wherein the controller has a lookup table that determines if a command signal is generated from the controller to the actuator.
